(19) United States
(12) Patent Application Publication
(10) Pub. No.: US 2002/0069207 A1
(43) Pub. Date: Jun. 6, 2002

(54) System and method for conducting surveys

(76) Inventors: Amy E. Alexander, Charleston, SC (US); Robert I. Jolley, Summerville, SC (US)

Correspondence Address: MICHAEL A MANN, NEXSEN PRUET JACOBS & POLLARD LLP, PO DRWR 2426, COLUMBIA, SC, 29202-2426, US

(21) Appl. No.: 09/731,087

(22) Filed: Dec. 6, 2000

(51) Int. Cl. G06F 7/00

(52) U.S. Cl. 707/102

(57) ABSTRACT

A computer system for creating, conducting and analyzing surveys. A “survey” encompasses a question or set of questions that elicit an answer or series of answers. The system has three modes of operation: survey setup, survey execution and report generation. Initially, an operator of the survey system will create a custom survey or select a pre-loaded survey, which is stored in a database as a computer object. The operator may also create a catalog of questions for re-use. The survey is executed by allowing a user to answer each question in the survey. Once the user has answered the questions, a variety of reports can be generated that allow analysis of the user's responses.

### FIELD OF THE INVENTION

The present invention relates to conducting surveys, particularly to a system and method for setting up and executing the survey.

### DISCUSSION OF BACKGROUND

Many organizations gather information ranging from general consumer information and census information to personal medical histories required prior to the rendering of medical services. It is convenient to keep and manage that information in electronic format. Typically, this information is gathered by hand and converted to electronic format using data entry.

In the health care industry, where there is constant pressure to limit the increases in costs, health care providers must capture and manage patient information efficiently. Unfortunately, the current method for gathering patient information requires the expenditure of considerable time by patients and staff personnel alike. For example, typically a patient is given a form to be filled out before seeing the doctor. The form may be mailed to the patient with instructions to bring it along to an appointment or it may be given to the patient upon arrival at the doctor's office. After the patient completes the form, a nurse reviews the entries on the form to verify that all of the questions have been answered and then keys the answers into a computer. As a result, reviewing the form and performing data entry require considerable time. Moreover, entering it twice, first onto a form and then into a computer, increases the chances of transcription errors, which can have serious consequences.

Whether in a medical practice setting or taking census data or gathering consumer preference information, efficiency and accuracy in obtaining survey data in electronic form is an important goal.

Therefore, there exists a need for a system that reduces the amount of time required to accumulate and enter survey information accurately into a computer system.

### SUMMARY OF THE INVENTION

The present invention is a computer system for creating, conducting and analyzing surveys using a data base and specialized software to facilitate surveying. The term “survey” encompasses a single question or set of questions.

The present system has three modes of operation: survey setup, survey execution and report generation. Initially, a manager of the survey system will create a custom survey, select a pre-loaded survey or select questions from a survey catalog using the present system. The survey is executed by having a user operate the present system to sequentially answer each question in the survey. Once the user has answered all questions, reports can be generated by the present system from those answers, including compilations of results and analytical reports.

The simplicity and ease of creating surveys, even relatively complex surveys, is a major advantage of the present invention. The survey manager need not understand database structure or programming to create a survey, but merely needs to create and enter the questions and answer pairings, and to follow simple instructions.

Having the capabilities to create a catalog of questions that are likely to be reused often and to categorize the questions for convenience is another major feature of the present invention. This feature also makes it easier to generate surveys since many questions that relate to family or social history for example may be asked repeatedly.

Another important advantage of the present invention is the electronic format of the survey. As a result, the paperwork required to be maintained by the survey manager is substantially reduced. Moreover, the electronic survey can be completed online wherever the user is located.

Another important feature of the present invention is the ability to import the results of the survey to electronic files. In the case of medical files for example, the physician need not send the results of the survey to a clearinghouse for conversion to digital format, but can import them easily from the present system.

Other features and advantages of the present invention will be apparent to those skilled in the art from a careful reading of the Detailed Description of Preferred Embodiments presented below and accompanied by the drawings.

### BRIEF DESCRIPTION OF THE DRAWINGS

In the drawings,

FIG. 1 illustrates the first window upon launching the application of a survey system according to a preferred embodiment of the present invention;

FIG. 2 illustrates a window used as a user interface for adding question-answer pairings and corresponding values in a software application for a survey system according to a preferred embodiment of the present invention;

FIG. 3 illustrates a window used as a user interface for selecting a title for a question from a catalog of titles in a software application for a survey system according to a preferred embodiment of the present invention;

FIG. 4 illustrates a window used as a user interface for previewing a survey in a software application of a survey system according to a preferred embodiment of the present invention;

FIG. 5 illustrates a window used as a user interface for altering answers to a survey in a software application of a survey system according to a preferred embodiment of the present invention;

FIG. 6 illustrates a window used as a user interface for executing a survey in a software application of a survey system according to a preferred embodiment of the present invention;

FIGS. 7A and 7B illustrate the question and its title as selected and illustrated in FIGS. 2 and 3 as the test taker would see it; and

FIG. 8 is a schematic diagram of the present system.

### DETAILED DESCRIPTION OF THE PREFERRED EMBODIMENTS

Referring now to the figures, the present invention is a computer system for creating, conducting and analyzing surveys. As shown in FIG. 8, system 10 involves use of a database 12, controlling software 14 and a user interface 16 for entering and accessing the items in database 12 via controlling software 14 in order to facilitate its three modes of operation: survey setup, survey execution and report generation. Controlling software 14 is in electronic communication with database 12 and user interface 16 and receives all instructions via user interface 16 to facilitate input and operation of system 10 by a user. Controlling software 14 accesses database 12, which stores surveys as computer objects, to transfer these objects to and from database 12.

Initially, an operator of the survey system, or survey manager, will create a custom survey, select a pre-loaded survey, select surveys from a catalog of surveys previously created, or a combination of these. By “pre-loaded”, it is meant that database 12 was purchased or leased with surveys already stored. This feature is especially useful when system 10 is being tailored to specific applications, such as medical practice questionnaires, consumer satisfaction surveys, voter preference surveys, and the like.

Then the survey is executed by allowing a user to answer each question in the survey. Once the user has answered each question, controlling software 14 can generate reports, including those that analyze the user's responses.

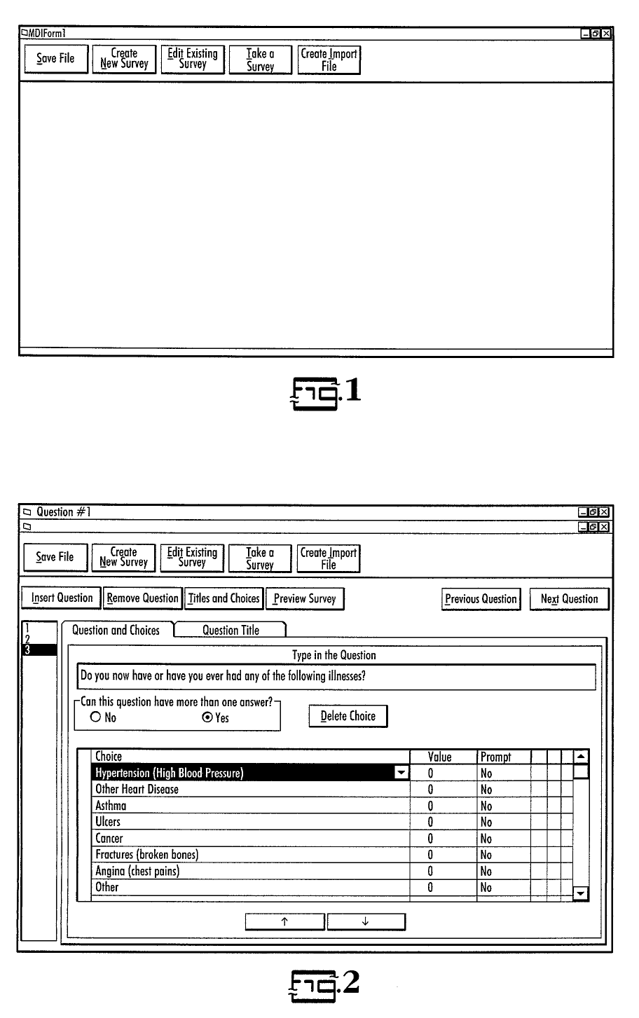

Referring now to FIG. 1, the survey manager launches the present application. User interface 16 is preferably windows-based, which is a type of user interface familiar to those skilled in conventional computer programming. Through user interface 16, controlling software 14 facilitates input and output of information between the user and system 10.

The survey manager is presented with four choices in the first window in the form of four virtual “buttons”: create a new survey, edit an existing survey, take a survey, or create an import file. A choice is made by “clicking” on the appropriate button.

To create the survey, the survey manager clicks on the button that corresponds to that choice and the application opens a window that allows the survey manager to begin selecting and creating questions, candidate answers and corresponding scores or values for each candidate answer. The survey manager enters the specific questions and candidate answers and their values, and assigns them to the survey. Although the survey may be assembled from pre-loaded sets of surveys, a custom survey can also be assembled and, as will be described, a survey can be assembled using previously created questions stored in a “catalog” in database 12.

The survey manager may also give each survey or part of a survey a title or heading so that the survey manager can better organize the survey and the user can better understand the context of the questions in that survey.

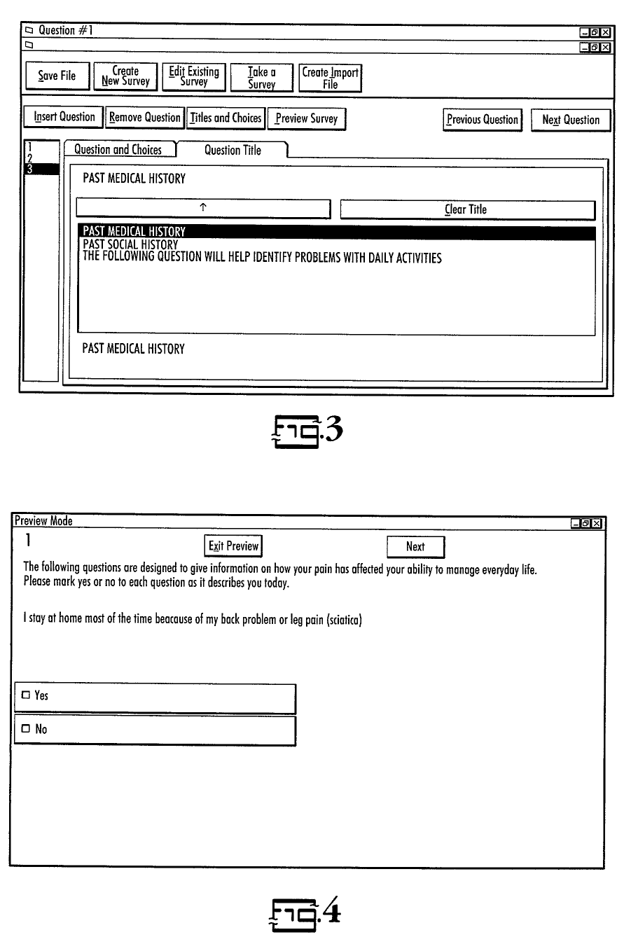

As illustrated in FIGS. 2 and 3, the survey manager clicks on the question number, types in the desired question, identifies whether the question has more than one answer and then selects the answer from the available choices. Each answer may be assigned a value as well. Every question may be given a title or heading. These items: number, question, candidate answers, and values are all then associated electronically by controlling software 14 as properties of a software “object”. Each survey is a software object in the present system, in the sense of the well-known “object-based” computer programming. Its properties include title, subheading, questions, answers and values. These objects are then stored in database 12 by controlling software 14.

Each question will be assigned a set of answers for the user to select. Preferably, there are four types of answers that can be associated with questions: either-or, either-or-other, multiple answer and free text. With an either-or answer, the user may only select one of the possible answers. An either-or-other answer allows the user to select a single suggested answer or to enter a more appropriate answer than those suggested. With a multiple answer question, the user can select as many suggested answers as appropriate. A free text answer does not provide any suggested answers, but allows the user to enter an appropriate answer.

Each survey may be assigned a score depending upon the responses of the user to individual questions. In setting up the survey, the survey manager may assign a value to each suggested answer. The survey, as taken, may then be assigned a score based upon the value or values corresponding to the response or responses given by the user.

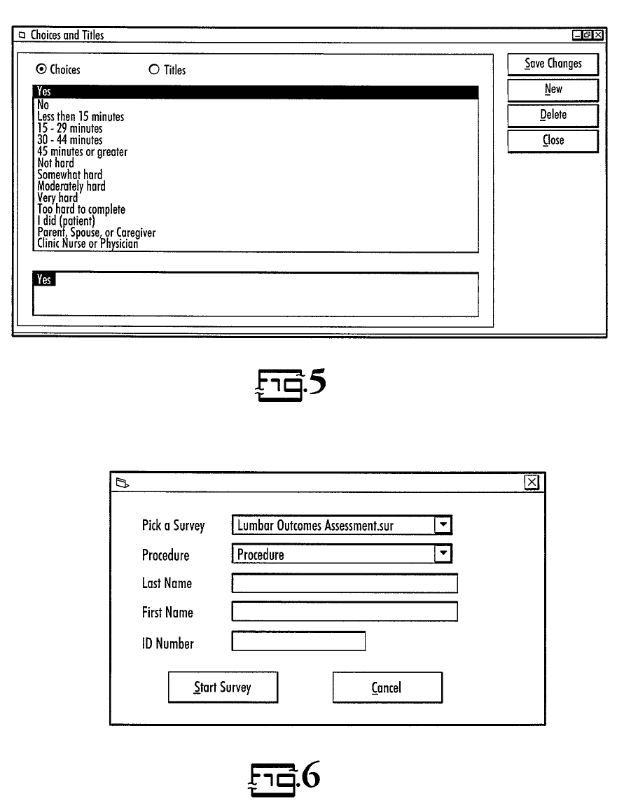

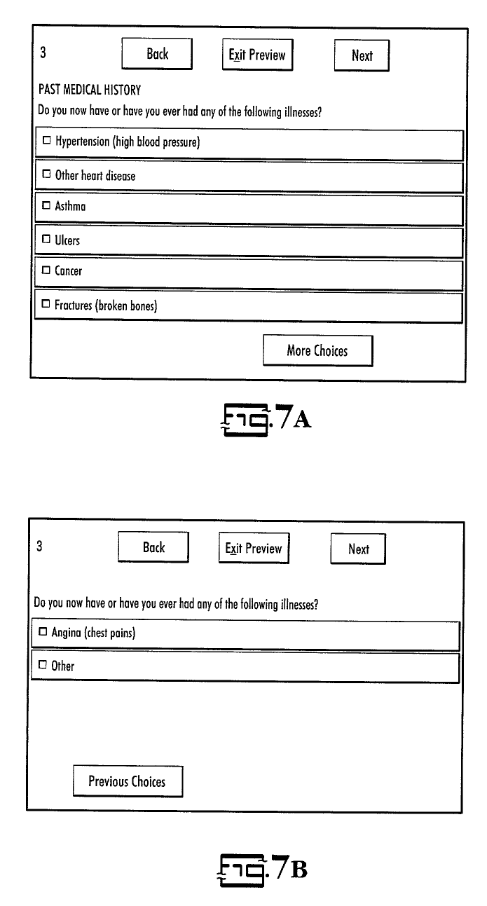

The survey manager may open windows that allow the survey manager to remove, edit or add questions (FIG. 2) from a survey, to select or alter a title (FIG. 3), to preview the survey (FIG. 4), and to alter or add answers and choices (FIG. 5).

The properties of the survey (title, subheading, questions, answers, values) as a computer object are transferred by controlling software 14 to and from database 12.

Many questions are useful in more than one survey. These can be saved in a “catalog” and classified by type for convenience. A “catalog” is simply a set of question and answer pairings stored as objects in database 12 where each pairing was created by the user for a previous survey and stored for use, preferably arranged or classified by type. For example, in medical practice surveys, questions on family history, social history and activities of daily living, may be stored under those classifications and summoned from database 12 when generating a new survey to speed up the process and avoid additional data entry. In political surveying or product preference surveys, questions about income and lifestyle are similarly going to be used repeatedly and can form a convenient classification of questions in a catalog of questions. Each question in the catalog is one created by the user but is stored and tagged for reuse by classification.

FIGS. 2, 3, 7A and 7B illustrate the inclusion into a survey of a question from a catalog of questions. In FIG. 2, the survey manager is presented with a window that enables the selection of a question, arbitrarily designated question 3, from the catalog regarding medical history. The question, previously generated and potentially previously used in other surveys, requests the test taker to identify which of eight illnesses he or she might have had in the past.

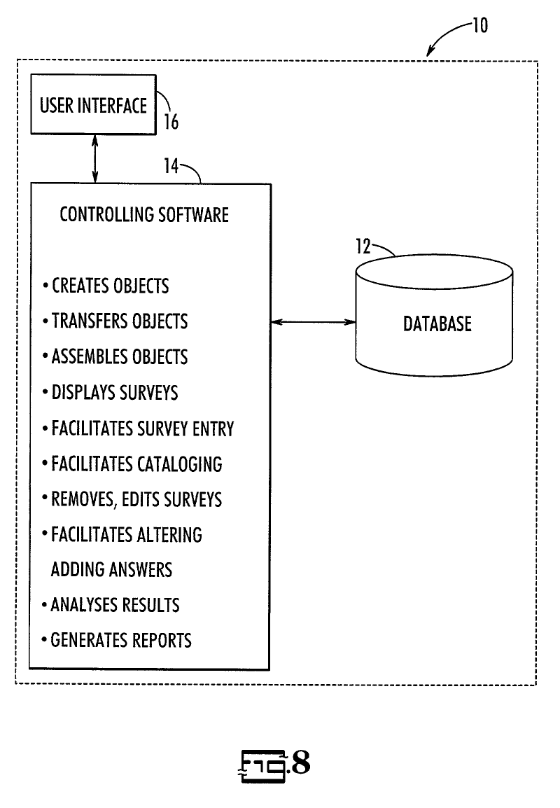

FIG. 3 illustrates the window the survey manager would see when selecting a title for this question. FIGS. 7A and 7B show the test as a test taker would see it when presented with question 3. Six of the choices listed in response to the question are presented on one window (FIG. 7A) and a prompt leads the user to the next window (FIG. 7B) for the remaining two choices.

Thus, the survey may be made up of pre-loaded questions, catalog questions and questions created ad hoc. The ad hoc questions can be added to the catalog in database 12 by controlling software 14 if they are deemed useful for other surveys.

System 10 may execute the survey locally or remotely; in other words, the user need not be in the same physical location as the hardware executing system 10. The user may access system 10 remotely via a network, such as an intranet, extranet, the Internet, or telephone. If system 10 is accessed remotely, the user will enter predetermined criteria, such as name and identification number (FIG. 5) to access and begin the appropriate survey. Alternatively, the user may access system 10 using a locally resident computer that permits only a limited number of surveys. If system 10 is locally accessed, the survey manager will enter predetermined information regarding the user to select the appropriate survey. System 10 may employ any one of numerous user interfaces, such as touch-sensitive screen, voice recognition, mouse, keyboard, and touch-tone phone.

In using system 10, user selects the appropriate responses using user interface 16 as is illustrated in FIGS. 7A and 7B and which is the window the application opens when the user selects the “taking the survey” option in the initial window. The user's responses are stored in database 12 for later retrieval.

Upon completing the survey, reports can be generated to indicate the results of the survey. Reports can be generated by a user's name, survey ID, specific date or date range, etc. Survey results can be generated in numerous formats depending upon the desired information to be gleaned from the survey. Preferably there are four formats that reports can be generated into: full, brief, specific question, statement. For the fully formatted report, a verbatim copy of the completed survey is generated while a brief formatted report lists only user name, title of survey and score. A “specific question” formatted report lists the user's responses for specifically selected questions. In a statement formatted report, the user's responses are generated as positive statements of the answers. A positive statement is a sentence that combines the answer given with the question asked. For example, if a user is asked “What best describes how you feel about your condition?” and selects the response “scared”, the statement formatted report would list: “The patient reports feeling scared about the condition.”

System 10 also enables importation into an electronic record with some formatting. The survey manager would simply select the type of electronic record software that the organization uses and system 10 will generate a report in the appropriate format to be imported into the record.

Those skilled in object-based programming and surveying will undoubtedly see many substitutions and modifications that can be made to the foregoing preferred embodiments but that do not depart from the spirit and scope of the present invention, which is defined by the appended claims.

What is claimed is:

1. A system for creating a survey, said system comprising:
(a) a database adapted for storing objects;
(b) controlling software in electronic communication with said database; and
(c) a user interface adapted for receiving instructions from a user and being in electronic communication with said controlling software so that a user can operate said system,
said controlling software including
(i) means for creating objects having properties of surveys in response to instructions via said user interface,
(ii) means for transfers said objects to and from said database,
(iii) means for assembling objects retrieved from said database in response to instructions via said user interface, and
(vi) means for displaying said surveys via said user interface.

2. The system as recited in claim 1, wherein said properties of said surveys stored as objects include a question, candidate answers and values.

3. The system as recited in claim 1, wherein said database is pre-loaded with surveys.

4. The system as recited in claim 1, wherein said controlling software further comprises means for facilitating entry of surveys via said user interface.

5. The system as recited in claim 1, wherein said controlling software further comprises means for cataloging said surveys for subsequent use.

6. The system as recited in claim 1, wherein said controlling software further comprises means for removing and editing surveys stored in said database.

7. The system as recited in claim 1, wherein said user interface is adapted to be used via a network.

8. The system as recited in claim 1, wherein said properties of said surveys stored as objects include a title, a subheading, a question, candidate answers and values.

9. The system as recited in claim 1, wherein said properties of said objects include answers, and wherein said controlling software further comprises means for altering and adding said answers of surveys stored in said database.

10. A system for providing survey information, said system comprising:
(a) a database adapted for storing objects;
(b) controlling software in electronic communication with said database; and
(c) a user interface adapted for receiving instructions from a user and being in electronic communication with said controlling software so that a user can operate said system,
said controlling software including
(i) means for creating objects having properties of surveys in response to instructions via said user interface,
(ii) means for transferring said objects to and from said database,
(iii) means for assembling objects retrieved from said database in response to instructions via said user interface,
(vi) means for displaying said surveys via said user interface, and
(v) means for receiving and storing responses to said surveys, said responses received by said controlling software from said user interface.

11. The system as recited in claim 10, wherein said controlling software further comprises means for analyzing said responses to said surveys.

12. The system as recited in claim 10, wherein said controlling software further comprises means for restating said responses as positive statements.

13. The system as recited in claim 10, wherein said controlling software further comprises means for generating reports containing information about said responses to said surveys.

14. A method for creating a survey, said method comprising the steps of:
providing a computer database;
generating a survey having a question and candidate answers; and
storing said survey as an object in a computer database, said question and said candidate answers being properties of said object.

15. The method as recited in claim 14, wherein said survey includes values corresponding to said candidate answers.

15. The method as recited in claim 14, further comprising the step of pre-loading said computer database with surveys.

16. The method as recited in claim 14, further comprising the step of providing a user interface means for facilitating input of said surveys into said computer database.
